(19) United States
(12) Patent Application Publication
(10) Pub. No.: US 2025/0063414 A1
(43) Pub. Date: Feb. 20, 2025

(54) METHOD AND APPARATUS FOR MANAGING ACTIVATION/DEACTIVATION OF MEASUREMENT GAP IN WIRELESS NETWORK

(71) Applicant: Samsung Electronics Co., Ltd., Gyeonggi-do (KR)

(72) Inventors: Aby Kanneath ABRAHAM, Bangalore (IN); Vinay Kumar SHRIVASTAVA, Bangalore (IN)

(21) Appl. No.: 18/723,032

(22) PCT Filed: Dec. 22, 2022
(86) PCT No.: PCT/KR2022/021084

§ 371 Date: Jun. 21, 2024

(30) Foreign Application Priority Data
Dec. 22, 2021 (IN) 202141059965
Dec. 12, 2022 (IN) 202141059965

(51) Int. Cl. H04W 24/10; H04W 64/00

(52) U.S. Cl. CPC H04W 24/10; H04W 64/00

(57) ABSTRACT

The disclosure relates to a 5G or 6G communication system for supporting a higher data transmission rate. Embodiments herein provide a method for managing measurement gap in a wireless network (1000) by a UE (100). The method includes sending a gap deactivation request message to a network apparatus (200) to deactivate the at least one measurement gap activated at the UE (100). Further, the method includes receiving a gap deactivation command message from the network apparatus (200) in response to the gap deactivation request message for deactivation of the at least one measurement gap activated at the UE. Further, the method includes deactivating the at least one measurement gap activated at the UE in response to receiving the gap deactivation command message from the network apparatus.

### TECHNICAL FIELD

The present disclosure relates to wireless communications, and more particularly to a method and a wireless network for activating and deactivating gaps in the wireless network.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

An aspect of the embodiments herein is to provide a method and a wireless network for activating and deactivating gaps in the wireless network (e.g., 5th Generation New Radio (5G NR) or the like). The method can be used for resolving the Hybrid Automatic Repeat Request, (HARQ) NACK-to-ACK errors.

Another aspect of the embodiments herein is to provide an activation and deactivation of preconfigured measurement gaps through MAC signalling.

Another aspect of the embodiments herein is to provide a MAC CE structure for activation and deactivation of preconfigured measurement gaps.

### Solution to Problem

Accordingly, the embodiment herein is to provide a method for managing measurement gap in a wireless network. The method includes detecting, by an User Equipment (UE) in the wireless network, at least one measurement gap activated at the UE. Further, the method includes sending, by the UE, a gap deactivation request message to a network apparatus in the wireless network to deactivate the at least one measurement gap activated at the UE. The gap deactivation request message includes at least one gap identifier of the at least one measurement gap activated at the UE. Further, the method includes receiving, by the UE, a gap deactivation command message from the network apparatus in response to the gap deactivation request message for deactivation of the at least one measurement gap activated at the UE. Further, the method includes deactivating, by the UE, the at least one measurement gap activated at the UE in response to receiving the gap deactivation command message from the network apparatus.

In an embodiment, the gap deactivation request message is sent in an Uplink (UL) Medium Access Control (MAC) Control Element (CE) to the network apparatus. The gap deactivation command message is received in a Downlink (DL) MAC CE from the network apparatus.

In an embodiment, the gap deactivation request message in the UL MAC CE comprises eight bits of information to identify the gap to be deactivated and a header comprising at least a specific value of logical channel identifier to identify the gap deactivation request in the UL MAC CE.

In an embodiment, the gap deactivation command message in the DL MAC CE comprises eight bits of information to identify the gap to be deactivated and a header containing at least a specific value of logical channel identifier to identify the gap deactivation command in the UL MAC CE.

In an embodiment, the gap deactivation command message does not include gap identifier of the at least one deactivated measurement gap when all the at least one measurement gaps requested by the UE is deactivated by the network apparatus.

In an embodiment, the gap deactivation command message deactivates a subset of the at least one measurement gaps and includes corresponding gap identifier when the subset of the at least one measurement gaps requested by the UE is deactivated by the network apparatus.

In an embodiment, the method includes sending, by the UE, a gap activation request message to the network apparatus in the wireless network to activate the gap at the UE. The gap activation request message includes at least one gap identifier of the at least one measurement gap for activation at the network apparatus. Further, the method includes receiving, by the UE, a gap activation command message from the network apparatus confirming activation of the at least one activated measurement gap at the network apparatus. Further, the method includes activating, by the UE, the at least one activated measurement gap at the UE based on a measurement gap configuration preconfigured at the UE in response to receiving the gap activation command message from the network apparatus.

In an embodiment, the gap activation request message is sent in an UL MAC CE to the network apparatus, and wherein the gap activation command message is received in a DL MAC CE from the network apparatus.

In an embodiment, the gap activation request message in the UL MAC CE comprises eight bits of information to identify the gap to be activated and a header comprising at least a specific value of logical channel identifier to identify the gap activation request in the UL MAC CE.

In an embodiment, the gap activation command message in the DL MAC CE comprises eight bits of information to identify the gap to be activated and a header containing at least a specific value of logical channel identifier to identify the gap activation command in the UL MAC CE.

In an embodiment, the gap activation command message does not include gap identifier of the at least one activated measurement gap when all measurement gaps requested by the UE is activated by the network apparatus.

In an embodiment, the gap activation command message activates a subset of the at least one measurement gap and includes corresponding gap identifier when the subset of the at least one measurement gaps requested by the UE is activated by the network apparatus.

Accordingly, the embodiment herein is to provide a method for managing measurement gap in a wireless network. The method includes receiving, by a network apparatus, a gap deactivation request message from a UE in the wireless network to deactivate at least one measurement gap activated at the UE. The gap deactivation request message includes at least one gap identifier of the at least one measurement gap activated at the UE. Further, the method includes deactivating, by the network apparatus, the at least one measurement gap activated at the UE based on the at least one gap identifier of the at least one measurement gap activated at the UE. Further, the method includes sending, by the network apparatus, a gap deactivation command message to the UE confirming deactivation of the at least one measurement gap activated at the UE, wherein the gap deactivation command message is sent without the gap identifier of the at least one measurement gap deactivated at the UE.

In an embodiment, the method includes receiving, by the network apparatus, a gap activation request message from the UE to activate the at least one measurement gap at the network apparatus. The gap activation request message comprises at least one gap identifier of the at least one measurement gap for activation at the network apparatus. Further, the method includes activating, by the network apparatus, the at least one measurement gap at the network apparatus based on the at least one gap identifier of the at least one measurement gap received from the UE. Further, the method includes sending, by the network apparatus, a gap activation command message to the UE confirming the activation of the at least one measurement gap at the network apparatus.

Accordingly, the embodiment herein is to provide a UE for managing measurement gap in a wireless network. The UE includes a measurement gap controller communicatively coupled to a memory and a processor. The measurement gap controller detects at least one measurement gap activated at the UE. Further, the measurement gap controller sends a gap deactivation request message to a network apparatus in the wireless network to deactivate the at least one measurement gap activated at the UE. The gap deactivation request message includes at least one gap identifier of the at least one measurement gap activated at the UE. Further, the measurement gap controller receives a gap deactivation command message from the network apparatus in response to the gap deactivation request message for deactivation of the at least one measurement gap activated at the UE. Further, the measurement gap controller deactivates the at least one measurement gap activated at the UE in response to receiving the gap deactivation command message from the network apparatus.

In an embodiment, the measurement gap controller sends a gap activation request message to the network apparatus in the wireless network to activate the gap at the UE. The gap activation request message includes at least one gap identifier of the at least one measurement gap for activation at the network apparatus. Further, the measurement gap controller receives a gap activation command message from the network apparatus confirming activation of the at least one activated measurement gap at the network apparatus. Further, the measurement gap controller activates the at least one activated measurement gap at the UE based on a measurement gap configuration preconfigured at the UE in response to receiving the gap activation command message from the network apparatus.

Accordingly, the embodiment herein is to provide a network apparatus for managing measurement gap in a wireless network. The network apparatus includes a measurement gap controller communicatively coupled to a memory and a processor. Further, the measurement gap controller receives a gap deactivation request message from a UE in the wireless network to deactivate at least one measurement gap activated at the UE. The gap deactivation request message includes at least one gap identifier of the at least one measurement gap activated at the UE. Further, the measurement gap controller deactivates the at least one measurement gap activated at the UE based on the at least one gap identifier of the at least one measurement gap activated at the UE. Further, the measurement gap controller sends a gap deactivation command message to the UE confirming deactivation of the at least one measurement gap activated at the UE. The gap deactivation command message is sent without the gap identifier of the at least one measurement gap deactivated at the UE.

Accordingly, the embodiment herein is to provide a method for managing measurement gap in a wireless network. The method includes receiving, by a UE in the wireless network, a timer or a counter from a network apparatus in the wireless network. Further, the method includes detecting, by the UE, an activation of at least one measurement gap at the UE. Further, the method includes detecting, by the UE, no scheduling requests until expiry of the timer or reaching a maximum limit of the counter corresponding to the at least one measurement gap activated at the UE. Further, the method includes deactivating, by the UE, the at least one measurement gap activated at the UE upon detecting the expiry of the timer or reaching the maximum limit of the counter, or retransmitting a request to the network apparatus for deactivation of the at least one measurement gap.

Accordingly, the embodiment herein is to provide a method for managing measurement gap in a wireless network. The method includes detecting, by a network apparatus, an activation of at least one measurement gap at the UE which is deactivated at the network apparatus. Further, the method includes detecting, by the network apparatus, an erroneous gap operation. Further, the measurement gap controller deactivating, by the network apparatus, the at least one measurement gap activated at the UE when the erroneous gap operation is detected. Further, the method includes sending, by the network apparatus, a gap deactivation command message to the UE to the deactivation of the at least one measurement gap activated at the UE.

In an embodiment, detecting, by the network apparatus, an erroneous gap operation includes at least one of monitoring discontinuous transmission for uplink scheduling allocated during the at least one measurement gap activated at the network apparatus, and monitoring whether downlink data is acknowledged successfully by the UE during the at least one measurement gap activated at the network apparatus.

Accordingly, the embodiment herein is to provide a UE for managing measurement gap in a wireless network. The UE includes a measurement gap controller communicatively coupled to a memory and a processor. The measurement gap controller receives a timer or a counter from a network apparatus in the wireless network. Further, the measurement gap controller detects an activation of at least one measurement gap at the UE. Further, the measurement gap controller detects no scheduling requests until expiry of the timer or reaching a maximum limit of the counter corresponding to the at least one measurement gap activated at the UE. Further, the measurement gap controller deactivates the at least one measurement gap activated at the UE upon detecting the expiry of the timer or reaching the maximum limit of the counter, or retransmitting a request to the network apparatus for deactivation of the at least one measurement gap.

Accordingly, the embodiment herein is to provide a network apparatus for managing measurement gap in a wireless network. The network apparatus includes a measurement gap controller communicatively coupled to a memory and a processor. The measurement gap controller detects an activation of at least one measurement gap at the UE which is deactivated at the network apparatus. Further, the measurement gap controller detects an erroneous gap operation. Further, the measurement gap controller deactivates the at least one measurement gap activated at the UE when the erroneous gap operation is detected. Further, the measurement gap controller sends a gap deactivation command message to the UE to the deactivation of the at least one measurement gap activated at the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The method and the wireless network are illustrated in the accompanying drawings, throughout which like reference letters indicate corresponding parts in the various figures. The embodiments herein will be better understood from the following description with reference to the drawings, in which:

FIG. 1A illustrates a wireless network for managing measurement gap, according to the embodiments as disclosed herein;

FIG. 1B shows various hardware components of a UE, according to the embodiments as disclosed herein;

FIG. 1C shows various hardware components of a network apparatus, according to the embodiments as disclosed herein;

FIG. 2 is a flow chart illustrating a method, implemented by the UE, for managing the measurement gap in the wireless network, according to the embodiments as disclosed herein;

FIG. 3 is a flow chart illustrating a method, implemented by the UE, for managing the measurement gap in the wireless network based on a timer or a counter, according to the embodiments as disclosed herein;

FIG. 4 is a flow chart illustrating a method, implemented by the network apparatus, for managing the measurement gap in the wireless network, according to the embodiments as disclosed herein;

FIG. 5 is a flow chart illustrating a method, implemented by the network apparatus, for managing the measurement gap in the wireless network based on a timer or a counter, according to the embodiments as disclosed herein;

FIG. 6 illustrating an example scenario of UE requested gap activation through MAC-CE, according to the embodiments as disclosed herein;

FIG. 7 illustrating an example scenario of UE requested gap deactivation through MAC-CE, according to the embodiments as disclosed herein;

FIG. 8 illustrating an example scenario of gNB (e.g., network apparatus) requested gap activation through MAC-CE, according to the embodiments as disclosed herein; and

FIG. 9 illustrating an example scenario of gNB requested gap deactivation through MAC-CE, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A “unit” may be configured in a storage medium that may be addressed or may be configured to reproduce one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a “unit” may be combined with additional elements or may be split into sub elements or sub-units. Further, an element or a “unit” may be implemented to reproduce one or more CPUs in a device or a security multimedia card. According to embodiments, a “ . . . unit” may include one or more processors.

As used herein, each of such phrases as “A/B”, “A or B”, “A and/or B”, “at least one of A and B”, “at least one of A or B”, “A, B, or C”, “at least one of A, B, and C”, and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for case of description. Thus, the disclosure is not limited to the terms, and the terms may be replaced with other terms denoting objects with equivalent technical meanings.

In the disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (IAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

The disclosure may be applied to post-5G next-generation systems (e.g., 6G systems) as well as 5G systems.

In wireless communications, when a user equipment (UE) needs to measure inter frequency new radio (NR) or inter-RAT measurements or intra frequency measurements outside an active downlink bandwidth part (BWP) when Synchronization Signal Block (SSB) is not completely contained in an active downlink (DL) BWP, the UE may use measurement gaps. The measurement gaps are configured by the wireless network (for e.g. gNB in NR) and there may not be any transmission or reception during a gap period. The measurement gap configuration includes a gap offset, gap length, repetition period, measurement gap timing advance etc. The gap offset specifies a subframe where the measurement gap occurs. The gap length gives the duration of the gap while the repetition period defines how often the measurement gap can occur.

The 3GPP has defined a number of measurement gap patterns—Each gap pattern corresponds to a gap length and a gap repetition period. For e.g. in release 16, there are 26 gap patterns defined. Measurement gap timing advance (mgta) specifies a timing advance value in milliseconds (ms). The gap occurs mgta milliseconds before the subframe given by the measurement gap offset. Up till Release 16 of NR, it was possible to configure only one measurement gap at a time. The NR release 17 introduces configuring and/or activating multiple measurement gaps at the same time. Each of these measurement gap within multiple measurement gaps will be having an identifier. A measurement object may be associated with a measurement gap identifier. Further when the UE is configured with multiple measurement gaps, the network may change the measurement gap associated with a measurement object.

Further, the NR Release 17 introduces preconfigured measurement gaps (pre-MG). While the legacy measurement gaps (measurement gaps till NR Release 16) are always on, the pre-MG can be either on or off based on communication between the network and the UE or based on some actions like BWP (BandWidth Part) switching. Preconfigured Measurement Gaps may be activated explicitly by the network through radio resource control (RRC) or Medium Access Control (MAC) signaling or implicitly based on the UE's and network understands of the need for measurement gaps.

Further in Release 17, a Multi Universal Subscriber Identity Module (MUSIM) UE containing two USIMs (for e.g. USIM-A and USIM-B) with at least one of the USIMs in RRC connected may request connected USIM's network to provide the gaps for opcrations in other USIM. 3GPP NR Release 17 considers the scenarios where one USIM (say USIM-A) is in RRC Connected and other USIM (say, USIM-B) is either in RRC Idle or RRC Inactive. The USIM-A can request for gaps from NW-A for operations in UE-B like paging monitoring, serving cell measurements, neighboring cell measurements and so on. MUSIM gaps can be configured through RRC signaling. The gNB and the UE uses either RRC signalling or MAC signalling for the activation or deactivation of gaps. 3GPP Release 18 brings in further enhancements for MUSIM opcrations, for e.g. support of Connected-Connected mode of operations where both the USIMs can be in RRC Connected.

GPP is also discussing other kinds of gaps—For e.g. FR2 UL gaps for detecting whether human body is close to UE's TX (transmission) antennas. 3GPP has also introduced gaps specifically used for positioning measurements (positioning measurement gap). Such gaps may be configured by RRC signalling and activated either by RRC or MAC signalling. For e.g. UE sends a medium access control element (MAC CE) to activate the gap. Similarly, there can be a number of other scenarios where gaps are applied.

From all of the above, we see that 3gpp is considering cases where gaps are configured first and then activated either by UE or gNB through MAC signalling (MAC-CE).

In current NR system, the MAC-CE is sent from network to UE to command for specific actions like SCell activation/deactivation, SP ZP CSI-RS Resource Set Activation/Deactivation, SP SRS Activation/Deactivation, Duplication Activation/Deactivation etc. The UE will perform the actions in the MAC-CE directly without response. Similarly, the UE also may send MAC-CE for Buffer Status Reporting (BSR), Power Headroom Reporting (PHR) etc.

In NR and earlier technologies like LTE, the measurement gaps are always configured by the network. Except for the measurement gaps used for positioning, the network (eNB in LTE, gNB in NR etc.) decides whether gaps are needed by the UE based on its own information and the capabilities reported by the UE since network decides when the UE needs to perform measurements. An exception is the positioning use case where it is the UE or the applications which use the positioning decides when to perform measurements. For positioning, a LTE UE or a NR UE sends the request through a RRC message like NR LocationMeasurementIndication to indicate that UE is going to start or stop the location measurements. On receiving the RRC message such as LocationMeasurementIndication, network such as gNB in NR or eNB in LTE used to configure or release the measurement gap. With the introduction of preconfigured gaps, UE may send the LocationMeasurementIndication to inform gNB that it has activated or deactivated the measurement gap. i.e. when a RRC message such as LocationMeasurementIndication is used for activation or deactivation of the measurement gap, they are activated or deactivated by a one way indication. This works sufficiently fine as RRC messages are protected by multiple layers of error correctionfor example RRC payload is transmitted using RLC (Radio Link Control in NR) Acknowledged mode (AM) and use RRC ARQ (Automatic Repeat Request) to ensure the reliability.

Accordingly, the embodiment herein is to provide a method for managing measurement gap in a wireless network. The method includes detecting, by an UE in the wireless network, at least one measurement gap activated at the UE. Further, the method includes sending, by the UE, a gap deactivation request message to a network apparatus in the wireless network to deactivate the at least one measurement gap activated at the UE. The gap deactivation request message includes at least one gap identifier of the at least one measurement gap activated at the UE. Further, the method includes receiving, by the UE, a gap deactivation command message from the network apparatus in response to the gap deactivation request message for deactivation of the at least one measurement gap activated at the UE. Further, the method includes deactivating, by the UE, the at least one measurement gap activated at the UE in response to receiving the gap deactivation command message from the network apparatus.

Unlike conventional methods, the proposed method can be used for resolving the HARQ NACK-to-ACK errors.

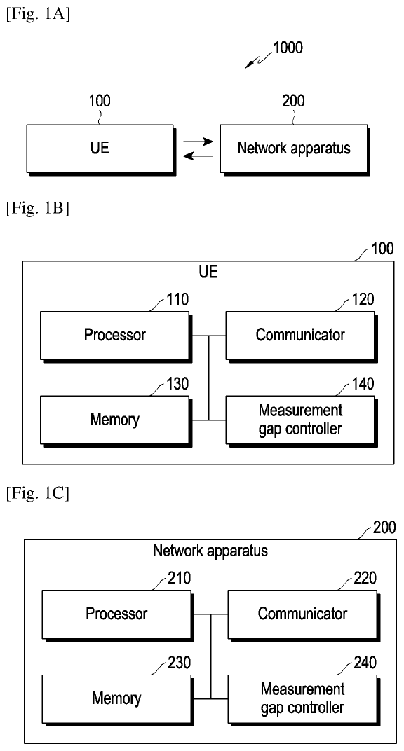

Referring now to the drawings and more particularly to FIGS. 1 through 9, where similar reference characters denote corresponding features consistently throughout the figures, there are shown preferred embodiments.

FIG. 1A illustrates a wireless network (1000) for managing measurement gap, according to the embodiments as disclosed herein. In an embodiment, the wireless network (1000) includes a UE (100) and a network apparatus (200). The UE (100) can be, for example, but not limited to a cellular phone, a smart phone, a Personal Digital Assistant (PDA), a tablet computer, a laptop computer, an Internet of Things (IoT), embedded systems, edge devices, a vehicle to everything (V2X) device or the like. The network apparatus (200) can also be referred as a base station, a new radio (NR) base station, an eNB, a gNB or the like. The wireless network (300) can be, for example, but not limited to, a fourth generation network, a fifth generation network, an open radio access network (ORAN) network or the like.

The UE (100) detects a measurement gap activated at the UE (100) and sends the gap deactivation request message to the network apparatus (200) to deactivate the measurement gap activated at the UE (100). The gap deactivation request message includes at least one gap identifier of the measurement gap activated at the UE (100). The network apparatus (200) receives the gap deactivation request message from the UE (100) and deactivates the measurement gap activated at the UE (100) based on the gap identifier of the measurement gap activated at the UE (100). Further, the network apparatus (200) sends a gap deactivation command message to the UE (100) confirming deactivation of the measurement gap activated at the UE (100). The gap deactivation command message is sent without the gap identifier of the measurement gap deactivated at the UE (100).

Further, the UE (100) receives the gap deactivation command message from the network apparatus (200) and deactivates the measurement gap activated at the UE (100) in response to receiving the gap deactivation command message from the network apparatus (200). If there is a HARQ NACK-To-ACK error during the transmission of gap deactivation request send by the UE (100), the UE (100) will not receive the gap deactivation command and will not deactivate the gap. Thus the synchronization issue between the UE (100) and the gNB for gap deactivation request will be resolved.

In the present disclosure, the gaps can be any gap in Radio Resource Control (RRC) connected mode, for e.g. measurement gaps (including the concurrent measurement gaps, preconfigured measurement gaps, positioning measurement gaps etc.), Multi Subscriber Identity Module (MUSIM) gaps, FR2 UL gaps etc. The proposed method performs a gap activation and gap de-activation which will be done by the UE (100) through a MAC-CE. Further, the proposed method performs gap activation and deactivation by the network apparatus (200) (e.g., gNB or the like) through the MAC-CE.

Hybrid Automatic Repeat Request (HARQ): The HARQ functionality in the NR ensures delivery between peer entities at Layer 1. The HARQ consists of a forward error correction (FEC) scheme and an automatic repeat request (ARQ) scheme. In the FEC scheme, a receiver corrects an error by appending an extra error correction code to information bits. In the ARQ scheme, when a received signal has an error, a transmitter corrects the error by retransmitting data. A hybrid ARQ (HARQ) scheme is a combination of the FEC scheme and the ARQ scheme.

According to the HARQ scheme, the receiver basically attempts error correction when data is received, and determines data retransmission by using an error detection code. For error detection, the transmitter can append a cyclic redundancy check (CRC) as the error detection code to the data to be transmitted. The receiver can detect an error of the received data by using the appended CRC. If no error is detected by the receiver by using the CRC, the receiver feeds back an acknowledgement (ACK) signal as a response signal to the transmitter. Otherwise, upon detecting an error from the received data, the receiver transmits a negative-acknowledgement (NACK) signal as a response signal to the transmitter. That is, the ACK/NACK signal is feedback on successful or unsuccessful reception of uplink data. The transmitter retransmits data upon receiving the NACK signal.

If the transmitter misunderstands NACK from a receiver as an ACK, it will not retransmit the data. This is called a NACK-To-ACK error. NACK-To-ACK errors will lead to incorrect system behaviour and usually upper layer protocols need to provide methods to handle such errors. Such methods include ARQ at RLC (Radio Link Control) or TCP level or application level retransmissions.

Similarly, if the transmitter misunderstands the ACK from a receiver to NACK, it will retransmit the data. This is called an ACK-To-NACK error. Usually this will lead to retransmission of the data and the receiver can discard such duplicated data. So it is comparatively less serious than NACK-To-ACK error.

Assume that one of the entities send a NACK to the received MAC signalling for activating the gaps. Peer entity need to retransmit the MAC signalling. But if the peer understands NACK as an ACK for gap activation, there will not be a retransmission, and the gap will remain activated in the peer that has activated the gap while the gaps will be deactivated in the other peer. Similarly, if the peer understands NACK as an ACK for gap deactivation, there will not be a retransmission, and the gap will remain deactivated in the peer that has deactivated the gap while the gaps will remain activated in the other peer.

It is possible for the UE (100) or the gNB to activate or deactivate the already configured gaps in technologies like NR through L2 signalling, i.e. MAC CE. Accordingly, the method consists of following four cases as below for possible NACK to ACK errors.

### 1. The UE (100) Sends a MAC CE to Activate the Gaps to the gNB:

When the MAC CE for activating a gap sent by the UE (100) is not successfully received by the gNB, the gNB sends the HARQ NACK to the UE (100). If the UE (100) identifies the HARQ NACK as an ACK, the UE (100) considers that the gap is activated, but in the gNB side the gap is still deactivated. As a result, the gNB will schedule the UE (100) even in the gaps, but UE (100) will not listen to the scheduling or will not receive the data in the gaps. This will lead to data loss and reduction in overall system efficiency.

### 2. The UE (100) Sends a MAC CE to Deactivate the Gaps to gNB.

When the MAC CE for deactivating a gap sent by the UE (100) is not successfully received by the gNB, the gNB sends a HARQ NACK to the UE (100). If the UE (100) identifies the HARQ NACK as an ACK, the UE (100) considers that the gap is deactivated, but in the gNB side the gap is still activated. The UE (100) will start to listen to scheduling or data in the gap. But since the gNB still considers the gap as activated, it will not schedule the UE (100) in the gap even though UE (100) doesn't need a gap. This will lead to a reduction in overall system efficiency.

### 3. The gNB Sends MAC CE to Activate the Gaps to the UE (100).

When the MAC CE for activating gaps sent by the gNB is not successfully received by the UE, UE sends HARQ NACK to gNB. If this HARQ NACK is not correctly received by the gNB and the gNB identifies the NACK as ACK, UE considers the gap as deactivated, but in the gNB side the gap is activated. As a result, gNB will not schedule the UE during the gap period, even though UE doesn't need the gaps anymore. This will lead to a reduction in overall system efficiency, and if the gaps are for measurement gaps, this will lead to insufficient measurements.

### 4. The gNB Sends MAC CE to Deactivate the Gaps to the UE (100).

When the MAC CE for deactivating gaps sent by the gNB is not successfully received by the UE (100), the UE (100) sends HARQ NACK to gNB. If the gNB identifies the HARQ NACK as ACK, the UE (100) considers the gap as activated, but in the gNB side the gap is deactivated. As a result, the gNB will schedule the UE (100) even in the gaps, but the UE (100) will not listen to the scheduling or will not receive the data in the gaps. This will lead to data loss and reduction in overall system efficiency.

Gap activation by the UE through MAC-CE—In an embodiment, the gaps are already configured by the gNB and UE (100) requests the gap activation to the gNB. For gap activation by the UE (100), the proposed method proposes a request-command approach through below 3 steps.
1. The UE (100) sends the MAC-CE to request to activate the gaps. In an example, this can be GAP ACTIVATION REQUEST MAC-CE.
2. The gNB transmits the MAC CE, for e.g. GAP ACTIVATION COMMAND in response to the MAC CE requesting gap activation from step 1 and then activates the gap.
3. On receiving above MAC CE, for e.g. GAP ACTIVATION COMMAND, UE (100) activates the gap.

In step 2, GAP ACTIVATION COMMAND, the gNB may not send any gap-id. The UE (100) will activate all the gaps requested. Alternatively, gNB may decide to activate a subset of gaps and include the corresponding gap ids.

As an alternative, the UE (100) may just send GAP ACTIVATION REQUEST MAC-CE and activate the gap. On receiving the GAP ACTIVATION REQUEST, the gNB also activates the gap without sending any further MAC-CE and to identify the NACK-To-ACK issues, the gNB monitors the DTX (discontinuous transmission) during the gaps for the uplink scheduling allocated during the gap. The gNB also monitors whether the downlink data is acknowledged successfully (at MAC or RLC (Radio Link Control)) during the gap. If the gNB observes that there is continuous DTX or data is not successfully acknowledged continuously, gNB identifies that there could be a NACK-To-ACK issue for the gap activation MAC CE by the UE and stops scheduling in the gap. The gNB may also send then GAP DEACTIVATION COMMAND MAC CE to explicitly deactivate the gap. In yet another method, gNB configures a timer or a counter to the UE through a RRC message. On the expiry of the timer or after the number of gaps after the configuration equals counter value, gaps are implicitly released. In yet another method, on identifying a scheduling during the gap, UE retransmits gap activation request and releases the gap implicitly or transmit a gap deactivation request.

The methods proposed will resolve the issue where the UE (100) considers gaps are activated, but gNB considers that the gaps are not activated due to HARQ NACKTo-ACK issues as in case 1 of the problem statement mentioned above. This will lead to the following changes in the MAC specification.
1. UL-SCH data transfer.
2. Gap Activation Request Transfer-If the UE is configured with a gap (a preconfigured gap or a MUSIM gap or a FR2-UL gap or a NTN gap etc.) and UE need to activate the gap, UE sends GAP ACTIVATION REQUEST MAC-CE including the gap-ids of the gaps to be activated.
3. Handling of MAC CEs.
4. Gap Activation Command-On receiving MAC CE GAP ACTIVATION COMMAND, if the command doesn't contain any gap-ids, if the gaps were requested previously by GAP ACTIVATION REQUEST MAC-CE UE activates the gaps requested.

Gap Deactivation by the UE (100) through MAC-CE—In this scenario, gaps is configured by the gNB and the UE requests the gap deactivation to gNB. Gaps may be previously activated by UE or gNB. For gap deactivation by the UE (100), the proposed method proposes a request-command approach through 3 steps.
1. The UE sends a MAC-CE to request to deactivate the gaps. In an example, this can be GAP DEACTIVATION REQUEST MAC-CE.
2. The gNB transmits a MAC CE, for e.g. GAP DEACTIVATION COMMAND in response to the MAC CE requesting gap deactivation from step1 and then deactivates the gap.
3. On receiving MAC CE, GAP DEACTIVATION COMMAND, UE deactivates the gap.

In step 2, GAP DEACTIVATION COMMAND, gNB may not send any gap-id and the UE will deactivate all the gaps requested. Alternatively, gNB may decide to include the corresponding gap ids and can deactivate the gaps or a subset of gaps.

In an alternative embodiment where the UE and gNB can deactivate the gap immediately after sending/receiving request without a command, the proposed method proposes that gNB configures the UE with a timer, gapDeactivationRetransmissionTimer or a counter, gapDeactivationRetransmissionCounter to check whether the UE is scheduled inside the gaps (i.e. whether the UE receives PDCCH (Physical Downlink Control Channel) or PDSCH (Physical Downlink Shared Channel) or is scheduled to transmit PUCCH (Physical Uplink Control Channel) or PUSCH (Physical Uplink Shared Channel) or other channels) after transmitting a MAC CE to deactivate the gap).

Further, the UE (100) receives the parameters gapDeactivationRetransmission Timer or gapDeactivationRetransmissionCounter in RRC messages like RRC Reconfiguration, RRC Resume or RRC Setup. If there is no scheduling (i.e. no transmission or reception on channels like PDCCH/PDSCH/PUSCH/PUCCH) inside the gap while gapDeactivationRetransmissionTimer is running or for a count of gapDeactivationRetransmissionCounter gaps, the UE retransmits the MAC CE for gap deactivation.

This helps in resolving the issue where the UE considers gaps are deactivated, but gNB considers that the gaps are activated due to HARQ NACK-To-ACK error when the UE sends a MAC CE to deactivate the gaps to gNB. This will lead to the following changes in the MAC specification.
1. UL-SCH data transfer
2. Gap Deactivation Request Transfer-If the UE needs to deactivate already activated gap(s), UE sends GAP ACTIVATION REQUEST MAC-CE including the gap-ids of the gaps to be deactivated.
3. Handling of MAC CEs
4. Gap Deactivation Command-On receiving MAC CE GAP ACTIVATION COMMAND, the UE (100) deactivates the gaps indicated by the command. If the command doesn't contain any gap-ids, if the gaps were requested previously by GAP ACTIVATION REQUEST MAC-CE UE deactivates the gaps requested.

Gap activation by the gNB through MAC-CE—In this scenario, gaps already configured is explicitly activated by the gNB through the MAC CE. For gap activation by the gNB, the proposed method proposes a command-confirm approach through below three steps.
1. The gNB sends a MAC-CE to request to activate the gaps. In an example, this can be GAP ACTIVATION COMMAND MAC-CE.
2. The UE (100) transmits a MAC CE, for e.g. GAP ACTIVATION CONFIRMATION in response to the MAC CE requesting gap activation from step1 and then activates the gap.
3. On receiving above MAC CE, for e.g. GAP ACTIVATION CONFIRMATION, gNB activates the gap.

Specification changes for capturing this scenario in TS 38.321 is as follows:
1. Handling of MAC CEs, and
2. Gap Activation Command-On receiving MAC CE GAP ACTIVATION COMMAND, the UE activates the gaps indicated by the command and sends GAP ACTIVATION CONFIRMATION to gNB.

The proposed method helps in resolving the issue where the UE considers gaps are not activated, but gNB considers that the gaps are activated due to HARQ NACK-To-ACK error when gNB sends a MAC CE to activate the gaps to the UE.

As an alternative when the UE (100) is not required to send GAP ACTIVATION CONFIRMATION, the gNB may retransmit the GAP ACTIVATION COMMAND after certain time based on its internal timer. In yet another alternative, the UE may be configured with a timer or a counter by gNB and if there is no scheduling within the time/count of configured gaps, the UE deactivates the gap or may own its own send gap activation request to gNB.

Gap Deactivation by the gNB through MAC-CE—In an embodiment, the gaps configured and already activated are explicitly deactivated by the gNB through a MAC-CE. For gap deactivation by the gNB, the proposed method proposes a command-confirm (or response) approach through 3 steps.
1. The gNB sends a MAC-CE to request to deactivate the gaps. In an example, this can be GAP DEACTIVATION COMMANDMAC-CE.
2. The UE transmits the MAC CE, for e.g. GAP DEACTIVATION CONFIRMATION in response to the MAC CE requesting gap deactivation from step1 and then deactivates the gap.
3. On receiving above MAC CE, for e.g. GAP DEACTIVATION CONFIRMATION, gNB deactivates the gap.

This can lead to the below changes in the TS 38.321 specification.
a) Handling of MAC CEs
b) Gap DeActivation Command

On receiving GAP DEACTIVATION COMMAND MAC-CE, UE deactivates the gaps with the gap-ids in the GAP DEACTIVATION COMMAND MAC CE and sends GAP DEACTIVATION CONFIRMATION.

This helps in resolving the issue where the UE considers gaps are not deactivated, but gNB considers that the gaps are deactivated due to HARQ NACK-To-ACK error when gNB sends the MAC CE to deactivate the gaps to the UE.

As an alternative where the UE is not required to send a DEACTIVATION CONFIRMATION MAC CE, the gNB monitors the DTX (discontinuous transmission) during the gaps for the uplink scheduling allocated during the gap. gNB also monitors whether the downlink data is acknowledged successfully (at MAC or RLC (Radio Link Control) during the gap. If the gNB observes that there is continuous DTX or data is not successfully acknowledged, gNB identifies that there could be a NACK-To-ACK issue for the gap activation MAC CE by the UE and stops scheduling in the gap. gNB also retransmits the MAC CE for gap deactivation.

Additionally, gNB may configure a timer GapDeactivationTimer to the UE which will be started with gap activation and on the expiry of the timer, gaps will be deactivated at UE.

GAP ACTIVATION CONFIRMATION or GAP DEACTIVATION CONFIRMATION can be identified with a specific value of logical channel identifier and zero size.

GAP ACTIVATION REQUEST, GAP ACTIVATION COMMAND, GAP DEACTIVATION REQUEST, GAP DEACTIVATION COMMAND can contains an octet, which communicates the activation/deactivation status of the corresponding gap. Each of the commands will have a specific value of logical channel identifiers in the MAC-CE header to identify the MAC-CE. In an example, the gap identifier can be included for identifying the gap in the MAC CE. In another example, MAC CE can contain multiple bits, each bit identifying a gap.

For e.g. if GO as shown in Table 1 is having a specific value (for e.g. 1), gap with gap-id 0 may be activated and if it is having other value (for e.g. 0), gap with gap-id 0 may be deactivated. Another option could be to use one value (for e.g. 1) for toggling the current gap activation status and another value (for e.g. 0) for keeping the current gap activation status.

TABLE 1

| | | | | | | | |
|---|---|---|---|---|---|---|---|
| G7 | G6 | G5 | G4 | G3 | G2 | G1 | G0 |

Above is an example of GAP ActivationRequest/GAPActivation Command/GAP Deactivation Request/GAP Deactivation Command (Excluding header).

To limit the size of the MAC CE and to reduce the corresponding overhead, 8 bits may be used in the body of the MAC CE.

FIG. 1B shows various hardware components of the UE (100), according to the embodiments as disclosed herein. In an embodiment, the UE (100) includes a processor (110), a communicator (120), a memory (130) and a measurement gap controller (140). The processor (110) is coupled with the communicator (120), the memory (130) and the measurement gap controller (140). The UE (100) may be implemented by including a transceiver (corresponding to the communicator (120)) for transmitting/receiving a signal and the processor (110).

The measurement gap controller (140) detects the measurement gap activated at the UE (100). Further, the measurement gap controller (140) sends the gap deactivation request message to the network apparatus (200) to deactivate the measurement gap activated at the UE (100). The gap deactivation request message includes the gap identifier of the measurement gap activated at the UE (100). In an embodiment, the gap deactivation request message is sent in the UL MAC CE to the network apparatus (200). The gap deactivation request message in the UL MAC CE includes eight bits of information to identify the gap to be deactivated and the header comprising at least a specific value of logical channel identifier to identify the gap deactivation request in the UL MAC CE.

In response to the gap deactivation request message for deactivation of the measurement gap activated at the UE (100), the measurement gap controller (140) receives the gap deactivation command message from the network apparatus (200). The gap deactivation command message is received in a DL MAC CE from the network apparatus (200). The gap deactivation command message in the DL MAC CE includes eight bits of information to identify the gap to be deactivated and the header containing at least a specific value of logical channel identifier to identify the gap deactivation command in the UL MAC CE. The gap deactivation command message does not include gap identifier of the at least one deactivated measurement gap when all the at least one measurement gaps requested by the UE (100) is deactivated by the network apparatus (200). The gap deactivation command message deactivates a subset of the at least one measurement gaps and includes corresponding gap identifier when the subset of the at least one measurement gaps requested by the UE (100) is deactivated by the network apparatus (200).

Further, the measurement gap controller (140) deactivates the measurement gap activated at the UE (100) in response to receiving the gap deactivation command message from the network apparatus (200).

Further, the measurement gap controller (140) sends the gap activation request message to the network apparatus (200) to activate the gap at the UE (100). The gap activation request message includes the gap identifier of the measurement gap for activation at the network apparatus (200). The gap activation request message is sent in the UL MAC CE to the network apparatus (200). The gap activation request message in the UL MAC CE comprises eight bits of information to identify the gap to be activated and a header comprising at least a specific value of logical channel identifier to identify the gap activation request in the UL MAC CE.

Further, the measurement gap controller (140) receives the gap activation command message from the network apparatus (200) confirming activation of the at least one activated measurement gap at the network apparatus (200). The gap activation command message is received in a DL MAC CE from the network apparatus (200). The gap activation command message in the DL MAC CE includes eight bits of information to identify the gap to be activated and a header containing at least a specific value of logical channel identifier to identify the gap activation command in the UL MAC CE. The gap activation command message does not include gap identifier of the at least one activated measurement gap when all measurement gaps requested by the UE (100) is activated by the network apparatus (200). The gap activation command message activates a subset of the at least one measurement gaps and includes corresponding gap identifier when the subset of the at least one measurement gaps requested by the UE (100) is activated by the network apparatus (200).

Further, the measurement gap controller (140) activates the activated measurement gap at the UE (100) based on a measurement gap configuration preconfigured at the UE (100) in response to receiving the gap activation command message from the network apparatus (200).

In another embodiment, the measurement gap controller (140) receives the timer or the counter from the network apparatus (200) and detects an activation of at least one measurement gap at the UE (100). Further, the measurement gap controller (140) detects no scheduling requests until expiry of the timer or reaching a maximum limit of the counter corresponding to the at least one measurement gap activated at the UE (100). Further, the measurement gap controller (140) deactivates the at least one measurement gap activated at the UE (100) upon detecting the expiry of the timer or reaching the maximum limit of the counter, or retransmitting the request to the network apparatus (200) for deactivation of the at least one measurement gap.

The measurement gap controller (140) is implemented by analog and/or digital circuits such as logic gates, integrated circuits, microprocessors (110), microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 1B shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 1C shows various hardware components of the network apparatus (200), according to the embodiments as disclosed herein. In an embodiment, the network apparatus (200) includes a processor (210), a communicator (220), a memory (230) and a measurement gap controller (240). The processor (210) is coupled with the communicator (220), the memory (230) and the measurement gap controller (240). The network apparatus (200) may be implemented by including a transceiver (corresponding to the communicator (220)) for transmitting/receiving a signal and the processor (210). In addition, The processor (210) may include the measurement gap controller (240).

The measurement gap controller (240) receives the gap deactivation request message from the UE (100) to deactivate the measurement gap activated at the UE (100). The gap deactivation request message includes the gap identifier of the measurement gap activated at the UE (100). The gap deactivation request message is received in the UL MAC CE. The gap deactivation request message in the UL MAC CE comprises eight bits of information to identify the gap to be deactivated and a header comprising a specific value of logical channel identifier to identify the UL MAC CE gap deactivation request.

Further, the measurement gap controller (240) deactivates the measurement gap activated at the UE (100) based on the gap identifier of the measurement gap activated at the UE (100).

Further, the measurement gap controller (240) sends the gap deactivation command message to the UE (100) confirming deactivation of the measurement gap activated at the UE (100). The gap deactivation command message is sent without the gap identifier of the measurement gap deactivated at the UE (100). The gap deactivation command message is sent in a DL MAC CE. The gap deactivation command message in the DL MAC CE comprises eight bits of information to identify the gap to be deactivated and a header containing a specific value of logical channel identifier to identify the UL MAC CE as gap deactivation command.

The gap deactivation command message does not include gap identifier of the deactivated measurement gap when all the measurement gaps requested by the UE (100) is deactivated by the network apparatus (200). The gap deactivation command message deactivates a subset of the measurement gaps and include corresponding gap identifier when the subset of the measurement gaps requested by the UE (100) is deactivated by the network apparatus (200).

Further, the measurement gap controller (240) receives the gap activation request message from the UE (100) to activate the measurement gap at the network apparatus (200). The gap activation request message includes the gap identifier of the measurement gap for activation at the network apparatus (200). The gap activation request message is sent in an UL MAC CE to the network apparatus (200). The gap activation request message comprising eight bits eight bits of information to identify the gap to be activated and a header comprising a specific value of logical channel identifier to identify the gap activation request in the UL MAC CE.

Further, the measurement gap controller (240) activates the measurement gap at the network apparatus (200) based on the gap identifier of the measurement gap received from the UE (100).

Further, the measurement gap controller (240) sends a gap activation command message to the UE (100) confirming the activation of the measurement gap at the network apparatus (200). The gap activation command message is received in a DL MAC CE from the network apparatus (200). The gap activation command message in the DL MAC CE comprising eight bits of information to identify the gap to be activated and a header containing a specific value of logical channel identifier to identify the gap activation command in the UL MAC CE. The gap activation command message does not include gap identifier of the activated measurement gap when all measurement gaps requested by the UE (100) is activated by the network apparatus (200). The gap activation command message activate a subset of the measurement gaps and include corresponding gap identifier when the subset of the measurement gaps requested by the UE (100) is activated by the network apparatus (200).

In another embodiment, the measurement gap controller (240) detects the activation of the measurement gap at the UE (100) which is deactivated at the network apparatus (200). Further, the measurement gap controller (240) detects an erroneous gap operation and deactivates the measurement gap activated at the UE (100) when the erroneous gap operation is detected. The erroneous gap operation includes at least one of monitoring discontinuous transmission for uplink scheduling allocated during the measurement gap activated at the network apparatus (200), and monitoring whether downlink data is acknowledged successfully by the UE (100) during the measurement gap activated at the network apparatus (200). Further, the measurement gap controller (240) sends the gap deactivation command message to the UE (100) to the deactivation of the measurement gap activated at the UE (100).

The measurement gap controller (240) is implemented by analog and/or digital circuits such as logic gates, integrated circuits, microprocessors (210), microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 1C shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

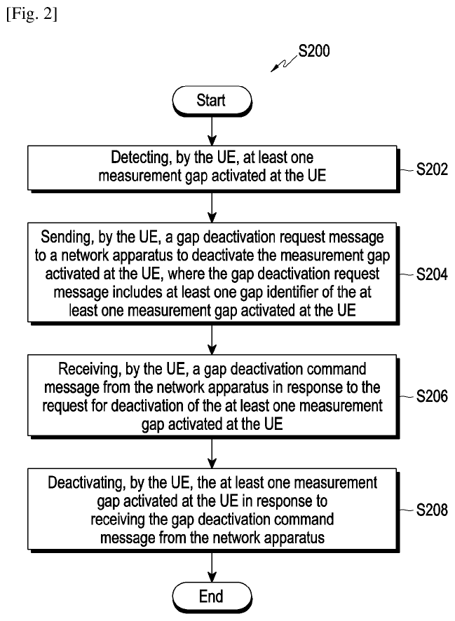

FIG. 2 is a flow chart (S200) illustrating a method, implemented by the UE (100), for managing the measurement gap in the wireless network (1000), according to the embodiments as disclosed herein. The operations (S202-S208) are implemented by the measurement gap controller (140).

At S202, the method includes detecting the at least one measurement gap activated at the UE (100). At S204, the method includes sending the gap deactivation request message to the network apparatus (200) to deactivate the at least one measurement gap activated at the UE (100). The gap deactivation request message includes at least one gap identifier of the at least one measurement gap activated at the UE (100). At S206, the method includes receiving the gap deactivation command message from the network apparatus (200) in response to the gap deactivation request message for deactivation of the at least one measurement gap activated at the UE (100). At S208, the method includes deactivating the at least one measurement gap activated at the UE (100) in response to receiving the gap deactivation command message from the network apparatus (200).

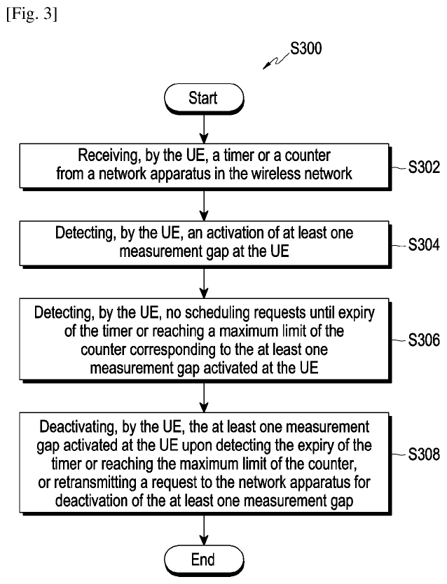

FIG. 3 is a flow chart (S300) illustrating a method, implemented by the UE (100), for managing the measurement gap in the wireless network (1000) based on the timer or the counter, according to the embodiments as disclosed herein. The operations (S302-S308) are implemented by the measurement gap controller (140).

At S302, the method includes receiving the timer or the counter from the network apparatus (200) in the wireless network (1000). At S304, the method includes detecting the activation of at least one measurement gap at the UE (100). At S306, the method includes detecting no scheduling requests until expiry of the timer or reaching a maximum limit of the counter corresponding to the at least one measurement gap activated at the UE (100). At S308, the method includes deactivating the at least one measurement gap activated at the UE (100) upon detecting the expiry of the timer or reaching the maximum limit of the counter, or retransmitting a request to the network apparatus (200) for deactivation of the at least one measurement gap.

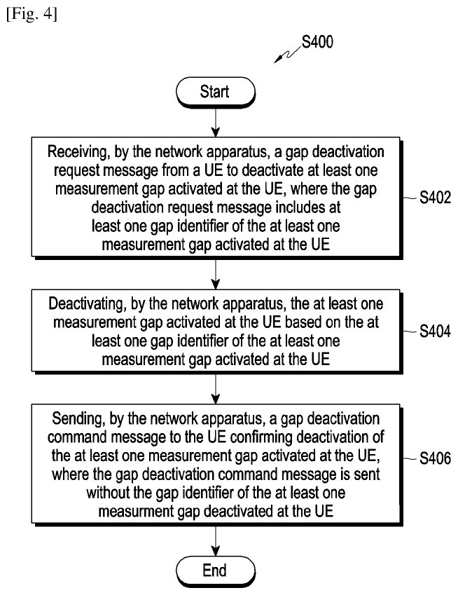

FIG. 4 is a flow chart (S400) illustrating a method, implemented by the network apparatus (200), for managing the measurement gap in the wireless network (1000), according to the embodiments as disclosed herein. The operations (S402-S406) are implemented by the measurement gap controller (240).

At S402, the method includes receiving the gap deactivation request message from the UE (100) to deactivate at least one measurement gap activated at the UE (100). The gap deactivation request message includes at least one gap identifier of the at least one measurement gap activated at the UE (100). At S404, the method includes deactivating the at least one measurement gap activated at the UE (100) based on the at least one gap identifier of the at least one measurement gap activated at the UE (100). At S406, the method includes sending the gap deactivation command message to the UE (100) confirming deactivation of the at least one measurement gap activated at the UE (100), wherein the gap deactivation command message is sent without the gap identifier of the at least one measurement gap deactivated at the UE (100).

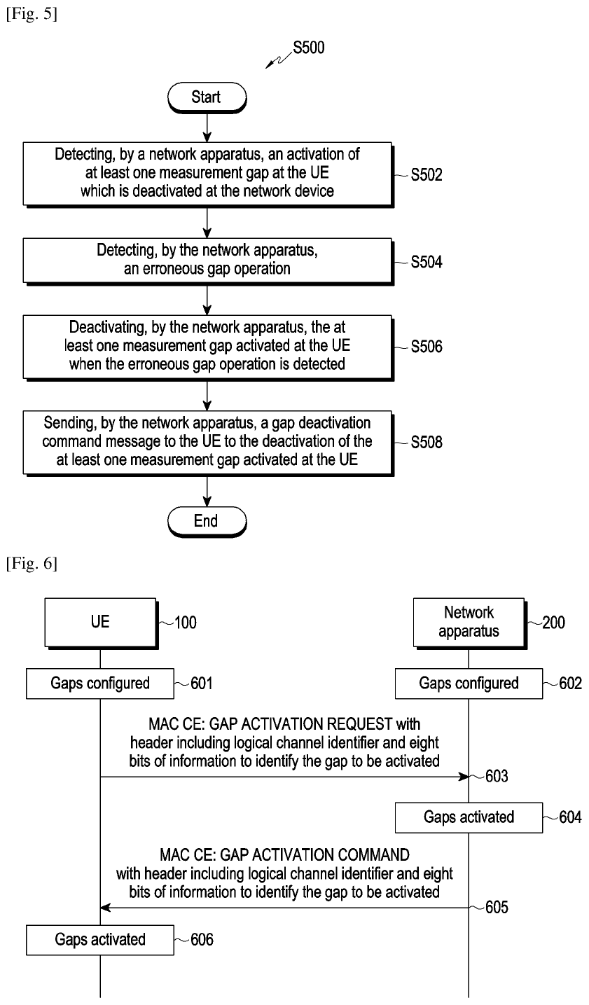

FIG. 5 is a flow chart (S500) illustrating a method, implemented by the network apparatus (200), for managing the measurement gap in the wireless network (1000) based on the timer or the counter, according to the embodiments as disclosed herein. The operations (S502-S508) are implemented by the measurement gap controller (240).

At S502, the method includes detecting the activation of at least one measurement gap at the UE (100) which is deactivated at the network apparatus (200). At S504, the method includes detecting the erroneous gap operation. At S506, the method includes deactivating the at least one measurement gap activated at the UE (100) when the erroneous gap operation is detected. At S508, the method includes sending a gap deactivation command message to the UE (100) to the deactivation of the at least one measurement gap activated at the UE (100).

FIG. 6 illustrates an example scenario of the UE (100) requested gap activation through the MAC-CE, according to the embodiments as disclosed herein. At 601, the gaps is configured at the UE (100). At 602, the gaps is configured at the network apparatus (200). At 603, the UE (100) sends the MAC CE: GAP ACTIVATION REQUEST with the header including logical channel identifier and eight bits of information to identify the gap to be activated to the network apparatus (200). At 604, the gaps is activated at the network apparatus (200). At 605, the network apparatus (200) sends the MAC CE: GAP ACTIVATION COMMAND the header including logical channel identifier and eight bits of information to identify the gap to be activated to the UE (100). At 606, the gaps is activated at the UE (100)

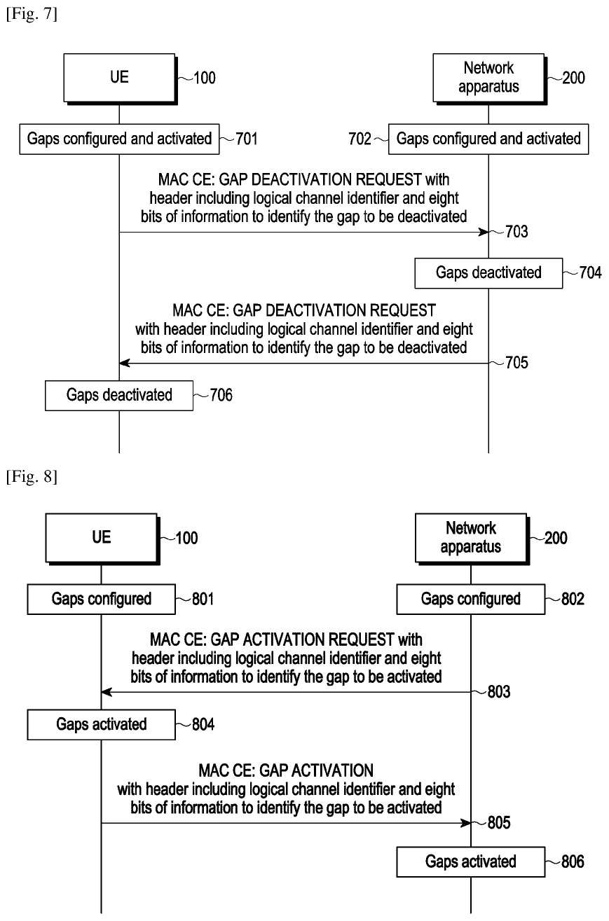

FIG. 7 illustrates an example scenario of the UE (100) requested gap deactivation through the MAC-CE, according to the embodiments as disclosed herein. At 701, the gaps is configured and activated at the UE (100). At 702, the gaps is configured and activated at the network apparatus (200). At 703, the UE (100) sends the MAC CE: GAP DEACTIVATION command with the header including logical channel identifier and eight bits of information to identify the gap to be deactivated to the network apparatus (200). At 704, the gaps is deactivated at the network apparatus (200). At 705, the network apparatus (200) sends the MAC CE: GAP DEACTIVATION CONFIRMATION with the header including the logical channel identifier and eight bits of information to identify the gap to be deactivated to the UE (100). At 706, the gaps is deactivated at the UE (100).

FIG. 8 illustrates an example scenario of an gNB (e.g., network apparatus) requested gap activation through the MAC-CE, according to the embodiments as disclosed herein. At 801, the gaps is configured at the UE (100). At 802, the gaps is configured at the network apparatus (200). At 803, the network apparatus (200) sends the MAC CE: GAP ACTIVATION REQUEST with the header including the logical channel identifier and eight bits of information to identify the gap to be activated to the UE (100). At 804, the gaps is activated at the UE (100). At 805, the UE (100) sends the MAC CE: GAP ACTIVATION CONFIRMATION with the header including the logical channel identifier and eight bits of information to identify the gap to be activated to the network apparatus (200). At 806, the gaps is activated at the network apparatus (200).

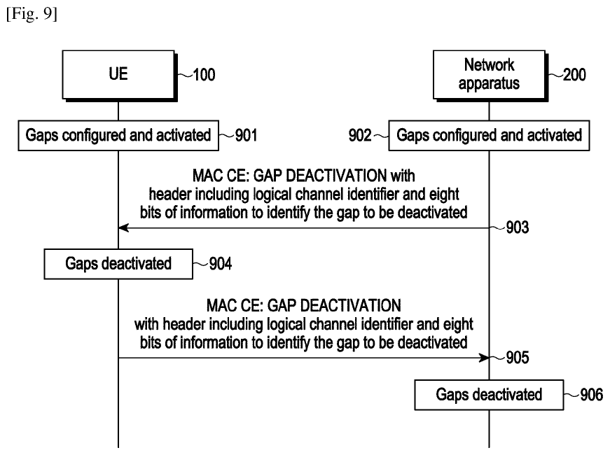

FIG. 9 illustrates an scenario of an gNB (e.g., network apparatus) requested gap de-activation through the MAC-CE, according to the embodiments as disclosed herein. At 901, the gaps is configured and activated at the UE (100). At 902, the gaps is configured and activated at the network apparatus (200). At 903, the network apparatus (200) sends the MAC CE: GAP DEACTIVATION command with the header including logical channel identifier and eight bits of information to identify the gap to be deactivated to the UE (100). At 904, the gaps is deactivated at the UE (100). At 905, the UE (100) sends the MAC CE: GAP DEACTIVATION CONFIRMATION the header including logical channel identifier and eight bits of information to identify the gap to be deactivated to the network apparatus (200). At 906, the gaps is deactivated at the network apparatus (200).

In an embodiment, a method for managing measurement gap in a wireless network (1000) is provided, wherein the method comprises detecting, by an User Equipment (UE) (100) in the wireless network (1000), at least one measurement gap activated at the UE (100), sending, by the UE (100), a gap deactivation request message to a network apparatus (200) in the wireless network (1000) to deactivate the at least one measurement gap activated at the UE (100), wherein the gap deactivation request message comprises at least one gap identifier of the at least one measurement gap activated at the UE (100), receiving, by the UE (100), a gap deactivation command message from the network apparatus (200) in response to the gap deactivation request message for deactivation of the at least one measurement gap activated at the UE (100), and deactivating, by the UE (100), the at least one measurement gap activated at the UE (100) in response to receiving the gap deactivation command message from the network apparatus (200).

In an embodiment, the gap deactivation request message is sent in an Uplink (UL) Medium Access Control (MAC) Control Element (CE) to the network apparatus (200), and wherein the gap deactivation command message is received in a Downlink (DL) MAC CE from the network apparatus (200).

In an embodiment, the gap deactivation request message in the UL MAC CE comprises eight bits of information to identify the gap to be deactivated and a header comprising at least a specific value of logical channel identifier to identify the gap de-activation request in the UL MAC CE.

In an embodiment, the gap deactivation command message in the DL MAC CE comprises eight bits of information to identify the gap to be deactivated and a header containing at least a specific value of logical channel identifier to identify the gap de-activation command in the UL MAC CE.

In an embodiment, the gap deactivation command message does not include gap identifier of the at least one deactivated measurement gap when all the at least one measurement gaps requested by the UE (100) is deactivated by the network apparatus (200).

In an embodiment, the gap deactivation command message deactivates a subset of the at least one measurement gaps and includes corresponding gap identifier when the subset of the at least one measurement gaps requested by the UE (100) is deactivated by the network apparatus (200).

In an embodiment, the method comprises sending, by the UE (100), a gap activation request message to the network apparatus (200) in the wireless network (1000) to activate the gap at the UE (100), wherein the gap activation request message comprises at least one gap identifier of the at least one measurement gap for activation at the network apparatus (200), receiving, by the UE (100), a gap activation command message from the network apparatus (200) confirming activation of the at least one activated measurement gap at the network apparatus (200), and activating, by the UE (100), the at least one activated measurement gap at the UE (100) based on a measurement gap configuration preconfigured at the UE (100) in response to receiving the gap activation command message from the network apparatus (200).

In an embodiment, the gap activation request message is sent in an UL MAC CE to the network apparatus (200), and wherein the gap activation command message is received in a DL MAC CE from the network apparatus (200).

In an embodiment, the gap activation request message in the UL MAC CE comprises eight bits of information to identify the gap to be activated and a header comprising at least a specific value of logical channel identifier to identify the gap activation request in the UL MAC CE.

In an embodiment, the gap activation command message in the DL MAC CE comprises eight bits of information to identify the gap to be activated and a header containing at least a specific value of logical channel identifier to identify the gap activation command in the UL MAC CE.

In an embodiment, the gap activation command message does not include gap identifier of the at least one activated measurement gap when all measurement gaps requested by the UE (100) is activated by the network apparatus (200).

In an embodiment, the gap activation command message activates a subset of the at least one measurement gaps and includes corresponding gap identifier when the subset of the at least one measurement gaps requested by the UE (100) is activated by the network apparatus (200).

In an embodiment, a method for managing measurement gap in a wireless network (1000) is provided, wherein the method comprises receiving, by a network apparatus (200), a gap deactivation request message from a UE (100) in the wireless network (1000) to deactivate at least one measurement gap activated at the UE (100), wherein the gap deactivation request message comprises at least one gap identifier of the at least one measurement gap activated at the UE (100), deactivating, by the network apparatus (200), the at least one measurement gap activated at the UE (100) based on the at least one gap identifier of the at least one measurement gap activated at the UE (100), and sending, by the network apparatus (200), a gap deactivation command message to the UE (100) confirming deactivation of the at least one measurement gap activated at the UE (100), wherein the gap deactivation command message is sent without the gap identifier of the at least one measurement gap deactivated at the UE (100).

In an embodiment, the gap deactivation request message is received in an Uplink (UL) MAC Control Element (CE), and wherein the gap deactivation command message is sent in a Downlink (DL) MAC CE.

In an embodiment, the gap deactivation request message in the UL MAC CE comprises eight bits of information to identify the gap to be deactivated and a header comprising at least a specific value of logical channel identifier to identify the UL MAC CE gap deactivation request.

In an embodiment, the gap deactivation command message in the DL MAC CE comprises eight bits of information to identify the gap to be deactivated and a header containing at least a specific value of logical channel identifier to identify the UL MAC CE as gap deactivation command.

In an embodiment, the gap deactivation command message does not include gap identifier of the at least one deactivated measurement gap when all the at least one measurement gaps requested by the UE (100) is deactivated by the network apparatus (200).

In an embodiment, the gap deactivation command message deactivates a subset of the at least one measurement gaps and include corresponding gap identifier when the subset of the at least one measurement gaps requested by the UE (100) is deactivated by the network apparatus (200).

In an embodiment, the method comprises receiving, by the network apparatus (200), a gap activation request message from the UE (100) to activate the at least one measurement gap at the network apparatus (200), wherein the gap activation request message comprises at least one gap identifier of the at least one measurement gap for activation at the network apparatus (200), activating, by the network apparatus (200), the at least one measurement gap at the network apparatus (200) based on the at least one gap identifier of the at least one measurement gap received from the UE (100), and sending, by the network apparatus (200), a gap activation command message to the UE (100) confirming the activation of the at least one measurement gap at the network apparatus (200).

In an embodiment, the gap activation request message is sent in an UL MAC CE to the network apparatus (200), and wherein the gap activation command message is received in a DL MAC CE from the network apparatus (200).

In an embodiment, the gap activation request message comprising eight bits eight bits of information to identify the gap to be activated and a header comprising at least a specific value of logical channel identifier to identify the gap activation request in the UL MAC CE.

In an embodiment, the gap activation command message in the DL MAC CE comprising eight bits of information to identify the gap to be activated and a header containing at least a specific value of logical channel identifier to identify the gap activation command in the UL MAC CE.

In an embodiment, the gap activation command message does not include gap identifier of the at least one activated measurement gap when all measurement gaps requested by the UE (100) is activated by the network apparatus (200).

In an embodiment, the gap activation command message activate a subset of the at least one measurement gaps and include corresponding gap identifier when the subset of the at least one measurement gaps requested by the UE (100) is activated by the network apparatus (200).

In an embodiment, a UE (100) for managing measurement gap in a wireless network (1000) is provided, wherein the UE (100) comprises a memory, a processor, and a measurement gap controller, communicatively coupled to the memory and the processor, configured to detect at least one measurement gap activated at the UE (100), send a gap deactivation request message to a network apparatus (200) in the wireless network (1000) to deactivate the at least one measurement gap activated at the UE (100), wherein the gap deactivation request message comprises at least one gap identifier of the at least one measurement gap activated at the UE (100), receive a gap deactivation command message from the network apparatus (200) in response to the gap deactivation request message for deactivation of the at least one measurement gap activated at the UE (100), and deactivate the at least one measurement gap activated at the UE (100) in response to receiving the gap deactivation command message from the network apparatus (200).

In an embodiment, the gap deactivation request message is sent in an Uplink (UL) Medium Access Control (MAC) Control Element (CE) to the network apparatus (200), and wherein the gap deactivation command message is received in a Downlink (DL) MAC CE from the network apparatus (200).

In an embodiment, the gap deactivation request message in the UL MAC CE comprises eight bits of information to identify the gap to be deactivated and a header comprising at least a specific value of logical channel identifier to identify the gap de-activation request in the UL MAC CE.

In an embodiment, the gap deactivation command message in the DL MAC CE comprises eight bits of information to identify the gap to be deactivated and a header containing at least a specific value of logical channel identifier to identify the gap de-activation command in the UL MAC CE.

In an embodiment, the gap deactivation command message does not include gap identifier of the at least one deactivated measurement gap when all the at least one measurement gaps requested by the UE (100) is deactivated by the network apparatus (200).

In an embodiment, the gap deactivation command message deactivates a subset of the at least one measurement gaps and includes corresponding gap identifier when the subset of the at least one measurement gaps requested by the UE (100) is deactivated by the network apparatus (200).

In an embodiment, the measurement gap controller is configured to send a gap activation request message to the network apparatus (200) in the wireless network (1000) to activate the gap at the UE (100), wherein the gap activation request message comprises at least one gap identifier of the at least one measurement gap for activation at the network apparatus (200), receive a gap activation command message from the network apparatus (200) confirming activation of the at least one activated measurement gap at the network apparatus (200), and activate the at least one activated measurement gap at the UE (100) based on a measurement gap configuration preconfigured at the UE (100) in response to receiving the gap activation command message from the network apparatus (200).

In an embodiment, the gap activation request message is sent in an UL MAC CE to the network apparatus (200), and wherein the gap activation command message is received in a DL MAC CE from the network apparatus (200).

In an embodiment, the gap activation request message in the UL MAC CE comprises eight bits of information to identify the gap to be activated and a header comprising at least a specific value of logical channel identifier to identify the gap activation request in the UL MAC CE.

In an embodiment, the gap activation command message in the DL MAC CE comprises eight bits of information to identify the gap to be activated and a header containing at least a specific value of logical channel identifier to identify the gap activation command in the UL MAC CE.

In an embodiment, the gap activation command message does not include gap identifier of the at least one activated measurement gap when all measurement gaps requested by the UE (100) is activated by the network apparatus (200).

In an embodiment, the gap activation command message activates a subset of the at least one measurement gaps and includes corresponding gap identifier when the subset of the at least one measurement gaps requested by the UE (100) is activated by the network apparatus (200).

In an embodiment, a network apparatus (200) for managing measurement gap in a wireless network (1000) is provided, wherein the network apparatus (200) comprises a memory, a processor, and a measurement gap controller, communicatively coupled to the memory and the processor, configured to receive a gap deactivation request message from a UE (100) in the wireless network (1000) to deactivate at least one measurement gap activated at the UE (100), wherein the gap deactivation request message comprises at least one gap identifier of the at least one measurement gap activated at the UE (100), deactivate the at least one measurement gap activated at the UE (100) based on the at least one gap identifier of the at least one measurement gap activated at the UE (100), and send a gap deactivation command message to the UE (100) confirming deactivation of the at least one measurement gap activated at the UE (100), wherein the gap deactivation command message is sent without the gap identifier of the at least one measurement gap deactivated at the UE (100).

In an embodiment, the gap deactivation request message is received in an Uplink (UL) MAC Control Element (CE), and wherein the gap deactivation command message is sent in a Downlink (DL) MAC CE.

In an embodiment, the gap deactivation request message in the UL MAC CE comprises eight bits of information to identify the gap to be deactivated and a header comprising at least a specific value of logical channel identifier to identify the UL MAC CE gap deactivation request.

In an embodiment, the gap deactivation command message in the DL MAC CE comprises eight bits of information to identify the gap to be deactivated and a header containing at least a specific value of logical channel identifier to identify the UL MAC CE as gap deactivation command.

In an embodiment, the gap deactivation command message does not include gap identifier of the at least one deactivated measurement gap when all the at least one measurement gaps requested by the UE (100) is deactivated by the network apparatus (200).

In an embodiment, the gap deactivation command message deactivates a subset of the at least one measurement gaps and include corresponding gap identifier when the subset of the at least one measurement gaps requested by the UE (100) is deactivated by the network apparatus (200).

In an embodiment, the measurement gap controller is configured to receive a gap activation request message from the UE (100) to activate the at least one measurement gap at the network apparatus (200), wherein the gap activation request message comprises at least one gap identifier of the at least one measurement gap for activation at the network apparatus (200), activate the at least one measurement gap at the network apparatus (200) based on the at least one gap identifier of the at least one measurement gap received from the UE (100), and send a gap activation command message to the UE (100) confirming the activation of the at least one measurement gap at the network apparatus (200).

In an embodiment, the gap activation request message is sent in an UL MAC CE to the network apparatus (200), and wherein the gap activation command message is received in a DL MAC CE from the network apparatus (200).

In an embodiment, the gap activation request message comprising eight bits eight bits of information to identify the gap to be activated and a header comprising at least a specific value of logical channel identifier to identify the gap activation request in the UL MAC CE.

In an embodiment, the gap activation command message in the DL MAC CE comprising eight bits of information to identify the gap to be activated and a header containing at least a specific value of logical channel identifier to identify the gap activation command in the UL MAC CE.

In an embodiment, the gap activation command message does not include gap identifier of the at least one activated measurement gap when all measurement gaps requested by the UE (100) is activated by the network apparatus (200).

In an embodiment, the gap activation command message activate a subset of the at least one measurement gaps and include corresponding gap identifier when the subset of the at least one measurement gaps requested by the UE (100) is activated by the network apparatus (200).

In an embodiment, a method for managing measurement gap in a wireless network (1000) is provided, wherein the method comprises receiving, by a UE (100) in the wireless network (1000), a timer or a counter from a network apparatus (200) in the wireless network (1000), detecting, by the UE (100), an activation of at least one measurement gap at the UE (100), detecting, by the UE (100), no scheduling requests until expiry of the timer or reaching a maximum limit of the counter corresponding to the at least one measurement gap activated at the UE (100), and deactivating, by the UE (100), the at least one measurement gap activated at the UE (100) upon detecting the expiry of the timer or reaching the maximum limit of the counter, or retransmitting a request to the network apparatus (200) for deactivation of the at least one measurement gap.

In an embodiment, a method for managing measurement gap in a wireless network (1000) is provided, wherein the method comprises detecting, by a network apparatus (200), an activation of at least one measurement gap at the UE (100) which is deactivated at the network apparatus (200), detecting, by the network apparatus (200), an erroneous gap operation, deactivating, by the network apparatus (200), the at least one measurement gap activated at the UE (100) when the erroneous gap operation is detected, and sending, by the network apparatus (200), a gap deactivation command message to the UE (100) to the deactivation of the at least one measurement gap activated at the UE (100).

In an embodiment, detecting, by the network apparatus (200), an erroneous gap operation comprises at least one of monitoring discontinuous transmission for uplink scheduling allocated during the at least one measurement gap activated at the network apparatus (200), and monitoring whether downlink data is acknowledged successfully by the UE (100) during the at least one measurement gap activated at the network apparatus (200).

In an embodiment, a UE (100) for managing measurement gap in a wireless network (1000) is provided, wherein the UE (100) comprises a memory, a processor, and a measurement gap controller, communicatively coupled to the memory and the processor, configured to receive a timer or a counter from a network apparatus (200) in the wireless network (1000), detect an activation of at least one measurement gap at the UE (100), detect no scheduling requests until expiry of the timer or reaching a maximum limit of the counter corresponding to the at least one measurement gap activated at the UE (100), and deactivate the at least one measurement gap activated at the UE (100) upon detecting the expiry of the timer or reaching the maximum limit of the counter, or retransmitting a request to the network apparatus (200) for deactivation of the at least one measurement gap.

In an embodiment, a network apparatus (200) for managing measurement gap in a wireless network (1000) is provided, wherein the network apparatus (200) comprises a memory, a processor, and a measurement gap controller, communicatively coupled to the memory and the processor, configured to detect an activation of at least one measurement gap at the UE (100) which is deactivated at the network apparatus (200), detect an erroneous gap operation, deactivate the at least one measurement gap activated at the UE (100) when the erroneous gap operation is detected, and send a gap deactivation command message to the UE (100) to the deactivation of the at least one measurement gap activated at the UE (100).

In an embodiment, The network apparatus (200) is configured to detect an erroneous gap operation comprises at least one of monitoring discontinuous transmission for uplink scheduling allocated during the at least one measurement gap activated at the network apparatus (200), and monitoring whether downlink data is acknowledged successfully by the UE (100) during the at least one measurement gap activated at the network apparatus (200).

The various actions, acts, blocks, steps, or the like in the flow charts of FIG. 2 to FIG. 9 may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a user equipment (UE) in a wireless communication system supporting a preconfigured measurement gap, the method comprising:
transmitting, to a base station, a measurement gap deactivation request including an identifier for the preconfigured measurement gap to deactivate the preconfigured measurement gap activated for the UE; and
receiving, from the base station, a measurement gap deactivation command including the identifier for the preconfigured measurement gap in response to transmission of the measurement gap deactivation request.

17. The method of claim 16, wherein each of the measurement gap deactivation request and the measurement gap deactivation command is signaled by a medium access control-control element (MAC-CE).

18. The method of claim 17, wherein the MAC-CE for each of the measurement gap deactivation request and the measurement gap deactivation command is identified by a specific value of a logical channel identifier in a MAC-CE header.

19. The method of claim 16, wherein the preconfigured measurement gap is used for a positioning measurement.

20. The method of claim 16, further comprising:
receiving, from the base station, configuration information for the preconfigured measurement gap;
transmitting, to the base station, a measurement gap activation request including the identifier for the preconfigured measurement gap to activate the preconfigured measurement gap for the UE; and
receiving, from the base station, a measurement gap activation command including the identifier for the preconfigured measurement gap in response to transmission of the measurement gap activation request.

21. A user equipment (UE) in a wireless communication system supporting a preconfigured measurement gap, the UE comprising:
a transceiver; and
a processor configured to:
transmit, to a base station, via the transceiver, a measurement gap deactivation request including an identifier for the preconfigured measurement gap to deactivate the preconfigured measurement gap activated for the UE, and
receive, via the transceiver, from the base station, a measurement gap deactivation command including the identifier for the preconfigured measurement gap in response to transmission of the measurement gap deactivation request.

22. The UE of claim 21, wherein each of the measurement gap deactivation request and the measurement gap deactivation command is signaled by a medium access control-control element (MAC-CE).

23. The UE of claim 22, wherein the MAC-CE for each of the measurement gap deactivation request and the measurement gap deactivation command is identified by a specific value of a logical channel identifier in a MAC-CE header.

24. The UE of claim 21, wherein the preconfigured measurement gap is used for a positioning measurement.

25. The UE of claim 21, wherein the processor is further configured to:
receive, via the transceiver, from the base station, configuration information for the preconfigured measurement gap,
transmit, to the base station, via the transceiver, a measurement gap activation request including the identifier for the preconfigured measurement gap to activate the preconfigured measurement gap for the UE, and
receive, via the transceiver, from the base station, a measurement gap activation command including the identifier for the preconfigured measurement gap in response to transmission of the measurement gap activation request.

26. A method performed by a base station in a wireless communication system supporting a preconfigured measurement gap, the method comprising:
receiving, from a user equipment (UE), a measurement gap deactivation request including an identifier for the preconfigured measurement gap to deactivate the preconfigured measurement gap activated for the UE; and
transmitting, to the UE, a measurement gap deactivation command including the identifier for the preconfigured measurement gap in response to receiving the measurement gap deactivation request.

27. The method of claim 26, wherein each of the measurement gap deactivation request and the measurement gap deactivation command is signaled by a medium access control-control element (MAC-CE).

28. The method of claim 27, wherein the MAC-CE for each of the measurement gap deactivation request and the measurement gap deactivation command is identified by a specific value of a logical channel identifier in a MAC-CE header.

29. The method of claim 26, wherein the preconfigured measurement gap is used for a positioning measurement.

30. The method of claim 26, further comprising transmitting, to the UE, configuration information for the preconfigured measurement gap;
receiving, from the UE, a measurement gap activation request including the identifier for the preconfigured measurement gap to activate the preconfigured measurement gap activated for the UE; and
transmitting, to the UE, a measurement gap activation command including the identifier for the preconfigured measurement gap in response to receiving the measurement gap activation request.

31. A base station in a wireless communication system supporting a preconfigured measurement gap, the base station comprising:
a transceiver; and
a processor configured to:
receive, via the transceiver, from a user equipment (UE), a measurement gap deactivation request including an identifier for the preconfigured measurement gap to deactivate the preconfigured measurement gap activated for the UE; and
transmit, via the transceiver, to the UE, a measurement gap deactivation command including the identifier for the preconfigured measurement gap in response to receiving the measurement gap deactivation request.

32. The base station of claim 31, wherein each of the measurement gap deactivation request and the measurement gap deactivation command is signaled by a medium access control-control element (MAC-CE).

33. The base station of claim 32, wherein the MAC-CE for each of the measurement gap deactivation request and the measurement gap deactivation command is identified by a specific value of a logical channel identifier in a MAC-CE header.

34. The base station of claim 31, wherein the preconfigured measurement gap is used for a positioning measurement.

35. The base station of claim 31, wherein the processor is further configured to:
transmit, to the UE, via the transceiver, configuration information for the preconfigured measurement gap,
receive, via the transceiver, from the UE, a measurement gap activation request including the identifier for the preconfigured measurement gap to activate the preconfigured measurement gap activated for the UE, and
transmit, to the UE, via the transceiver, a measurement gap activation command including the identifier for the preconfigured measurement gap in response to receiving the measurement gap activation request.
